(19) United States
(12) Patent Application Publication
(10) Pub. No.: US 2004/0104273 A1
(43) Pub. Date: Jun. 3, 2004

(54) Identification tag

(76) Inventor: Yatsuka Nakamura, Nagano (JP)

Correspondence Address: BIRCH STEWART KOLASCH & BIRCH, PO BOX 747, FALLS CHURCH, VA, 22040-0747, US

(21) Appl. No.: 10/720,229

(22) Filed: Nov. 25, 2003

(30) Foreign Application Priority Data
Jul. 16, 2001 (JP) 2001-214964

(51) Int. Cl. G06K 21/00

(52) U.S. Cl. 235/489

(57) ABSTRACT

An identification tag 1 provided with a random pattern P readable with an image sensor 2 is configured by three-dimensionally disposing at least a pair of random pattern members 4a and 4b generating moiré fringes M forming the random pattern P in a transparent medium 3. Through this configuration, the moiré fringes M are generated by the random pattern members 4a and 4b and the moiré fringes M serve as a random pattern P (identification information) peculiar to respective identification tags 1 and so on which are difficult to be forged (copied).

### BACKGROUND OF THE INVENTION

1. Field of the Invention

The present invention relates to an identification tag suitably used for an identification card or the like having random patterns which are readable by an image sensor.

2. Description of the Relevant Art

Generally, since magnetic cards on which identification information is written magnetically or IC cards having a data memory function are apt to be forged (copied) or identification information written in the cards are apt to be stolen, development of an identification tag which can reliably prevent forgery or data theft has been publicly requested.

As an identification tag resistant to forgery or data theft a data carrier (identification tag) disclosed in Japanese Patent Laid-open No. 10 (1998)-44650 has been known, for instance. The data carrier disclosed in the above Patent Bulletin is a data carrier having an identification information section prepared for user's peculiar identification information, and the identification information section is prepared by simultaneous molding of monochromatic thermoplastic resin pellets as a base board and metal fragments to be disposed at random by an extruder.

However, though such a conventional identification tag (the data carrier) are difficult to forge or steal data from due to the random disposition of metal fragments, there are problems such as being vulnerable to copying or the like of identification information with, for instance, a copying machine because the metal fragments forming a random pattern are directly readout, difficulty of manufacturing, difficulty of quality assurance, and so on. Therefore, the technology is still unable to ensure a sufficient reliability and security.

### SUMMARY OF THE INVENTION

An object of the present invention is to provide an identification tag with enhanced reliability and security, employing moiré fringes to improve resistance to be copied or the like with a copying machine as identification information, and to avoid forgery and data theft more reliably.

Another object of the present invention is to provide an identification tag which can be manufactured easily, in high quality and at low cost.

In order to achieve these objects, the present invention is characterized by that when an identification tag provided with a random pattern readable with an image sensor is formed, at least one pair of random pattern members which generate moiré fringes to form the random pattern is disposed three-dimensionally in a transparent medium. The identification tag thus structured generates moiré fringes by the random pattern members, and the moiré fringes serve as a random pattern (identification information) peculiar to respective identification tags which are not easily forged (copied).

### BRIEF DESCRIPTION OF THE DRAWINGS

FIG. 1 is a perspective view showing an outside appearance of an identification card having an identification tag according to the preferred embodiment of the present invention;

FIG. 2 is a plan view showing the identification tag in the identification cards;

FIG. 3 is a cross section of the side elevation view showing a portion of the identification cards;

FIG. 4 is an explanatory view of an identification tag structure in the identification cards;

FIG. 5 is a block diagram of an identification apparatus for the identification cards; and

FIG. 6 is a cross section of the side elevation view showing a portion of the identification cards provided with the identification tag according to a modified embodiment of the present invention.

### DETAILED DESCRIPTION OF THE PREFERRED EMBODIMENT(S)

Next, a preferable embodiment relating to the present invention will be cited and explained in detail with reference to the drawings. It should be noted that the attached drawings are not for specifying the present invention but to facilitate understanding of the present invention. As for well-known portions, in order to avoid making the present invention obscure, detailed explanation will be omitted.

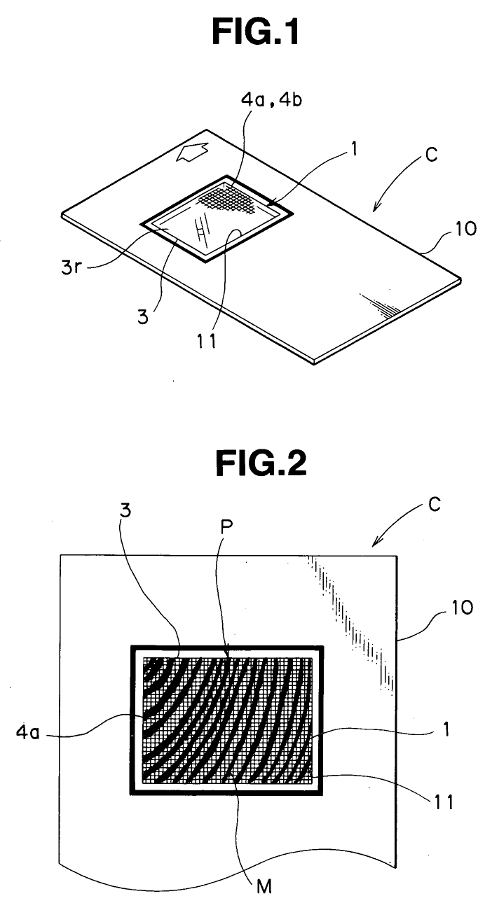

First, the configuration of the identification tag 1 according to the present embodiment and the method of manufacturing thereof will be explained with reference to FIGS. 1 to 4.

The embodiment presents the case of using the identification tag 1 for identification cards C such as credit cards, cash cards and the like.

The identification cards C have a card base board 10 formed in a card shape as a whole, as shown in FIG. 1, and a rectangular aperture window 11 formed on a predetermined position of the card base board 10. In the meantime, a pair of net members 4an and 4bn is prepared for use as random pattern members 4a and 4b. In order to picture the net members 4an and 4bn, it is recommended to think of, for instance, a fabric such as that used to make stockings made by weaving fine synthetic fibers in a lattice. When this kind of fabric is used for the net members 4an and 4bn, the sizes and shapes of respective lattices come to be different from each other.

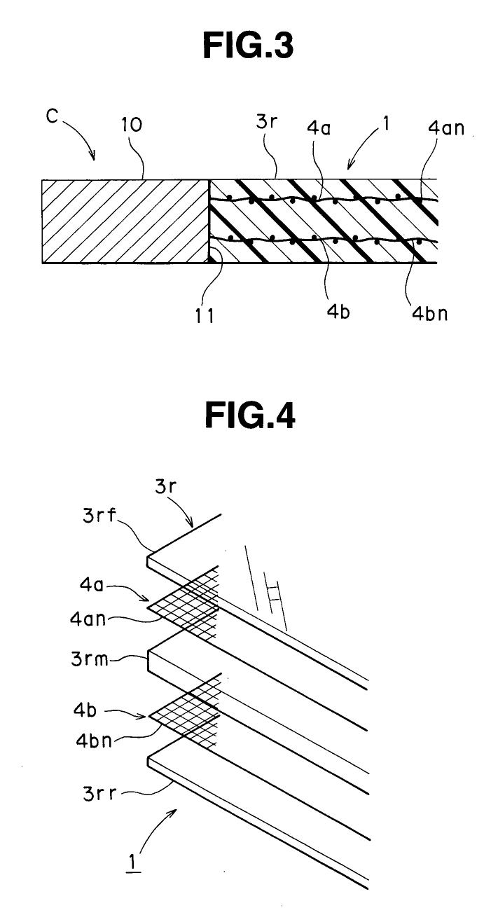

The net members 4an and 4bn prepared thus are arranged three-dimensionally, and are insert molded with a synthetic resin 3r to be a transparent medium 3. More specifically, the insert molding can be easily carried out by setting a pair of net members 4an and 4bn thus-prepared in layers in the mold cavity of a molding machine at a predetermined distance apart from each other (see FIG. 3), and pouring a molten synthetic resin 3r into the cavity. It should be noted that the size (area) of the whole molded product is arbitrary, and in the case of molding a product having a large area, an identification tag 1 to be an object product can be obtained by cutting the molded product to the required size when in use.

Then, identification cards C shown in FIG. 1 can be obtained by fitting the identification tag 1 obtained thus into the aperture window 11 of the card base board 10. As described above, since the identification tag 1 (identification cards C) according to the present embodiment uses a pair of net members 4an and 4bn made of fabric, a high-quality product can be manufactured easily, and at low cost.

It should be noted that by selecting the thickness of the fiber and the tightness of the lattice forming the net members 4an and 4bn, the storage capacity of the identification tag 1 can be varied. Furthermore, any relative angle between net member 4an and net member 4bn can be accepted. That is, the weave textures of respective net members 4an and 4bn may be disposed in the same direction (in parallel) or the net members 4an and 4bn may be disposed with a small degree of angle between respective net members so that the weave texture direction of the net member 4bn slants against that of the net member 4an. The colors of the net members 4an and 4bn are also arbitrary, and a design such as a pattern or the like can be added as necessary. When a whitish color is used for instance, the merit of copy protection is enhanced.

FIG. 4 schematically shows a positional relationship between the net members 4an and 4bn in the synthetic resin 3r for the identification tag 1. The figure shows a state in which a middle layer 3rm of the synthetic resin 3r exists between the net members 4an and 4bn, and a protective layer 3rf exists on the outside of one net member 4an, while another protective layer 3rr exists on the outside of the other net member 4bn.

Moiré fringes M can be generated by using such net members 4an and 4bn. More concretely, when seen from a specific distance away with respect to the identification tag 1, the moiré fringes M shown in FIG. 2 can be recognized. The moiré fringes M and the net members 4an and 4bn form a random pattern P which serves as unique identification information in respective identification cards C . . . . Accordingly, no two cards can exist with the same identification information.

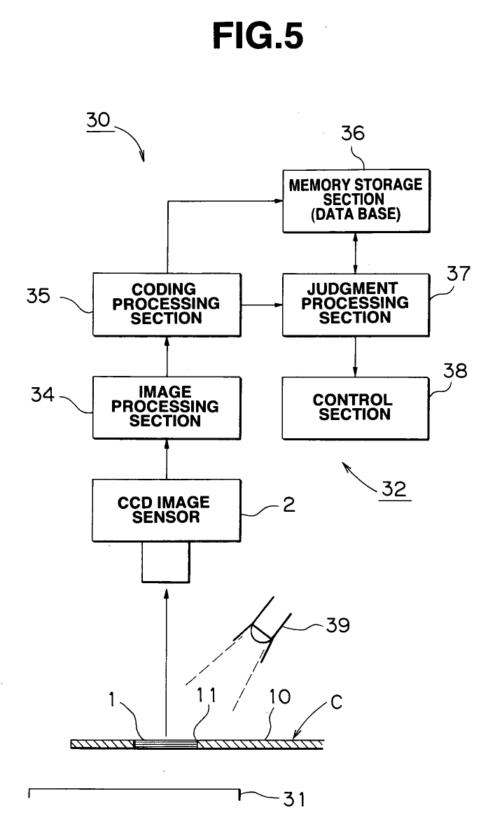

A method of reading the random pattern P, namely, the method to identify the identification cards C will be explained next with reference to FIG. 5.

In FIG. 5, 30 indicates the identification apparatus. 31 indicates the base board, and as the color of the base board 31, a color which easily generates the moiré pattern M on the identification tag 1 should be selected. For instance, when a whitish color is selected for the net members 4an and 4bn, a blackish color is recommended for the base board 31. 32 indicates an identification processing system having a computing function which comprises an image sensor (such as a CCD) 2 disposed confronting the base board 31, an image processing section 34, a coding processing section 35, a memory storage section 36, a judgment processing section 37, and a control section 38. Further, 39 indicates an illuminating section to illuminate the identification card C on set.

In such an identification apparatus 30, the identification card C is set between the base board 31 and the image sensor 2 as shown in FIG. 5, and the identification card C on set is illuminated by the illuminating section 39. Through this formation, since the moiré fringes M are generated on the identification tag 1 in the aperture window 11 of the identification card C, the random pattern P in the aperture window 11 including the moiré fringes M is read, namely, picked up by the image sensor 2. In the meantime, a read signal from the image sensor 2 is given to the image processing section 34. A binarizing processing of the readout signal is performed in the image processing section 34, and the binarized data obtained thus is given to the coding processing section 35. In the coding processing section 35, the binarized data are subjected to data compression by a cipher system to obtain objective identification data (identification information).

When the identification apparatus 30 is operating in a registration mode, the identification data obtained from the coding processing section 35 is registered in the memory storage section 36 and changed into a data base. On the other hand, when the identification apparatus 30 is operating in an identification mode, the identification data obtained from the coding processing section 35 is given to the judgment processing section 37. Through this processing, the judgment processing section 37 performs the identification processing whether the given identification data exists in the data base of the memory storage section 36 or not. As a result, if the consistent identification data exists, an identification signal is given to the control section 38. The control section 38 admits the processing to proceed to the next step, if, for instance, the identification card C is a cash card. On the contrary, if there exists no identification data consistent with the data in the memory storage section 36, a processing for this situation, for instance, a message indicating impossibility of identification is performed using a display or voice.

Thus, the identification tag 1 according to the present embodiment generates the moiré fringes M forming a peculiar random pattern P by the random pattern members 4a and 4b, which makes it difficult to forge (copy) the identification information. In addition to that, even if a copying operation is performed with a copying machine or the like, it is impossible to copy the moiré fringes M three-dimensionally, which means that it is difficult to steal and misuse the identification information. As described above, the reliability and security of the identification tag 1 is drastically enhanced.

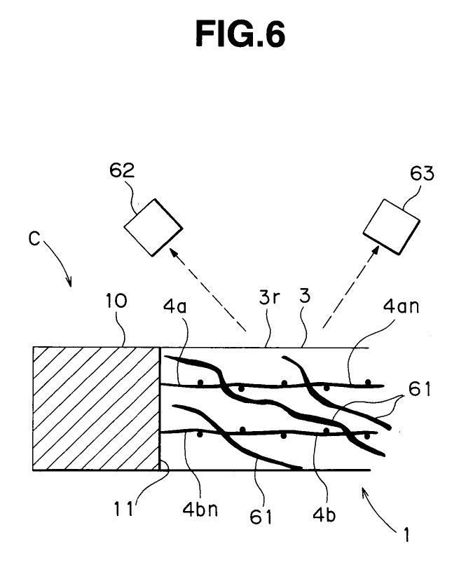

Incidentally, FIG. 6 shows a modified embodiment. The modified embodiment uses a transparent synthetic resin 3r to which colored ink is poured as a transparent medium 3. Through this structure, a flow pattern 61 as shown in FIG. 6 is given to the transparent medium 3. As a result, in the modified embodiment, the random pattern P can be more complicated, which can be employed additionally in the embodiments shown in FIG. 1 to FIG. 3.

Further, the modified embodiment presents the case of disposing the image sensors 62 and 63 at two positions different from each other, and reading the identification tag 1 from a slant angle. By adopting such a three-dimensional reading system, it becomes possible to avoid data theft such as copying by a copying machine and the like more successfully. Incidentally, in FIG. 6, the same portions as in FIG. 3 are given the same symbols or numerals to clarify the configuration, and detailed explanation thereof will be omitted.

As described above, the present embodiments have been explained in detail. However, the present invention is not limited to these embodiments, it should be considered to be acceptable to modify any detail of configuration or method of implementation without departing from the spirit of the present invention, and at the same time to add or cancel some details as necessary. For instance, in the embodiment, though the case of disposing a pair of random pattern members 4a and 4b is shown, it is not intended to exclude a case of disposing three or more random pattern members 4a, 4b, and so on in so-called three or more layers. And, though the case of using fabric made of fiber as the net members 4an and 4bn is explained, it is needless to say that a net member using a metal wire or the like is also acceptable. Further, though the case of fitting and fixing the identification tag 1 prepared separately into the aperture window 11 of the card base board 10 is shown as the embodiment, the identification tag 1 and the card base board 10 can be integrally molded. In addition, as the usage of the identification tag 1, the case of using it for the identification cards C is explained, but it can be used for any identification of passports, licenses, and so on.

What is claimed is:

1. An identification tag provided with a random pattern readable with an image sensor, said identification tag comprising;
at least a pair of random pattern members generating moiré fringes forming said random pattern, being disposed three-dimensionally in a transparent medium.

2. The identification tag according to claim 1, wherein a transparent synthetic resin is used as said transparent medium.

3. The identification tag according to claim 1 or claim 2, wherein said transparent medium is provided with a flow pattern.

4. The identification tag according to claim 1, wherein a net member is used as said random pattern member.

5. The identification tag according to claim 4, wherein fabric made of fiber is used as said net members.

6. The identification tag according to claim 1, wherein said identification tag is used for identification cards.
